(19) United States
(12) Patent Application Publication
(10) Pub. No.: US 2016/0273568 A1
(43) Pub. Date: Sep. 22, 2016

(54) DIY LEG FRAME AND DIY FURNITURE USING SAME

(71) Applicant: Kwang Chon CHOI, Icheon-si (KR)

(72) Inventor: Kwang Chon CHOI, Icheon-si (KR)

(21) Appl. No.: 15/034,876

(22) PCT Filed: Nov. 6, 2014
(86) PCT No.: PCT/KR2014/010629

§ 371 Date: May 6, 2016

(30) Foreign Application Priority Data
Nov. 8, 2013 (KR) 10-2013-0135447
Nov. 6, 2014 (KR) 10-2014-0153569

(51) Int. Cl. F16B 12/44; F16M 11/22; A47C 7/00; A47C 19/02; A47B 13/02; A47B 87/00

(52) U.S. Cl. CPC F16B 12/44; A47B 13/02; A47B 87/007; A47C 7/00; A47C 19/024; F16M 11/22

(57) ABSTRACT

The present invention relates to a DIY leg frame and DIY furniture using the DIY leg frame, particularly, a DIY leg frame having at least two coupling holes that are transversely formed to fit rectangular members and having a body, in which one of the coupling holes is formed perpendicular to at least another coupling hole, and DIY furniture using the DIY leg frame so that a user can easily M and stably manufacture DIY furniture in a desired shape and size.

### TECHNICAL FIELD

The present invention relates to a DIY leg frame and DIY furniture using the same and, particularly, a DIY leg frame that allows a user to easily make strong DIY furniture in a desired shape and size, and DIY furniture using the DIY leg frame.

### BACKGROUND ART

In general, furniture means products such as a chair, a bench, a desk, a table, a bed, a flat bench, and a display stand and various types of furniture are made to be suited to preferences of users and sold by many manufacturers.

However, the manufactures have difficulty in making in large quantity furniture that can satisfy all shapes, sizes, colors, and materials, etc, which are desired by users, and users have to pay considerable costs to request customized furniture from manufacturers.

DIY furniture has been proposed recently to solve this problem. DIY, an abbreviation of “Do It Yourself”, means that a person assembles a product him or herself and uses it. In other words, a user purchases half-machined materials having desired shape, size, color, and quality and then assembles a complete product in person, thereby making DIY furniture.

Such DIY furniture has been proposed in Korean Patent No. 10-0725230 (hereafter, referred to as a ‘cited reference 1’) and Korean Utility Model No. 20-0429011 (hereafter, referred to as ‘cited reference 2’).

The cited references 1 and 2 relate to bookshelves and users can make desired bookshelves by assembling the materials, but as shown in FIGS. 1 and 2, the cited references 1 and 2 provide DIY materials only for the shapes of furniture designed by providers, so it is impossible to assemble various pieces of furniture using the materials provided by manufacturers, and accordingly, there is no variability of use. Further, as the structures of the material for making DIY bookshelves are complicated, the providers have difficulty in producing the materials and costs are correspondingly increased.

### DISCLOSURE

### Technical Problem

The present invention has been made in an effort to solve the problems and an object of the present invention is to provide a DIY leg frame that allows a user to make various types of DIY furniture desired shapes and sizes in a firm structure using even simple materials, and DIY furniture using the DIY leg frame.

### Technical Solution

In order to achieve the objects, a DIY leg frame of the present invention having at least two coupling holes that are transversely formed to fit rectangular members and having a body, in which one of the coupling holes is formed perpendicular to at least another coupling hole.

Further, in order to achieve the objects, DIY furniture is formed by vertically placing a plurality of DIY leg frames on the floor and fitting rectangular members having predetermined lengths, in which at least two rectangular members are fitted through the DIY leg frames perpendicularly to each other.

### Advantageous Effects

According to the present invention, rectangular members can be fitted perpendicular to each other in the DIY leg frame, so it is possible to manufacture firm DIY furniture. Further, the rectangular members can be fitted through the DIY leg frame and another rectangular member can be coupled to the rectangular members fitted through the DIY leg frame. Accordingly, variability of use for various types of furniture is provided, so demands of users can be satisfied and convenience is improved. Therefore, mass production is possible by the variability of use and DIY furniture can be manufactured at a low cost.

### DESCRIPTION OF DRAWINGS

FIGS. 1 and 2 are views showing examples of DIY furniture structures of the related art.

FIG. 3 is a perspective view showing an example of a DIY leg frame according to the present invention.

FIG. 4 is an exemplary view showing a process of manufacturing an embodiment of DIY furniture using DIY leg frames according to the present invention.

FIG. 5 is a perspective view showing an example of a DIY leg frame according to the present invention.

FIGS. 6 and 7 are exemplary views showing rectangular members assembled through DIY leg frame according to the present invention.

FIGS. 8a and 8b are exemplary views showing a process of manufacturing an embodiment of DIY furniture using DIY leg frames according to the present invention.

FIG. 9 is a perspective view showing an example of a DIY leg frame according to the present invention.

FIG. 10 is a perspective view showing a finishing member that is fitted in a hole formed in a DIY leg frame according to the present invention.

FIGS. 11a to 11c are exemplary views showing a process of manufacturing an embodiment of DIY furniture using DIY leg frames according to the present invention.

FIGS. 12a to 12c are exemplary views showing a process of manufacturing an embodiment of DIY furniture using DIY leg frames according to the present invention.

FIGS. 13 and 14 are exemplary views showing rectangular members assembled through a DIY leg frame according to the present invention.

FIGS. 15a to 15d are exemplary views showing a process of manufacturing an embodiment of DIY furniture using DIY leg frames according to the present invention.

FIGS. 16 and 17 are partial enlarged views showing the structure a DIY leg frame according to the present invention.

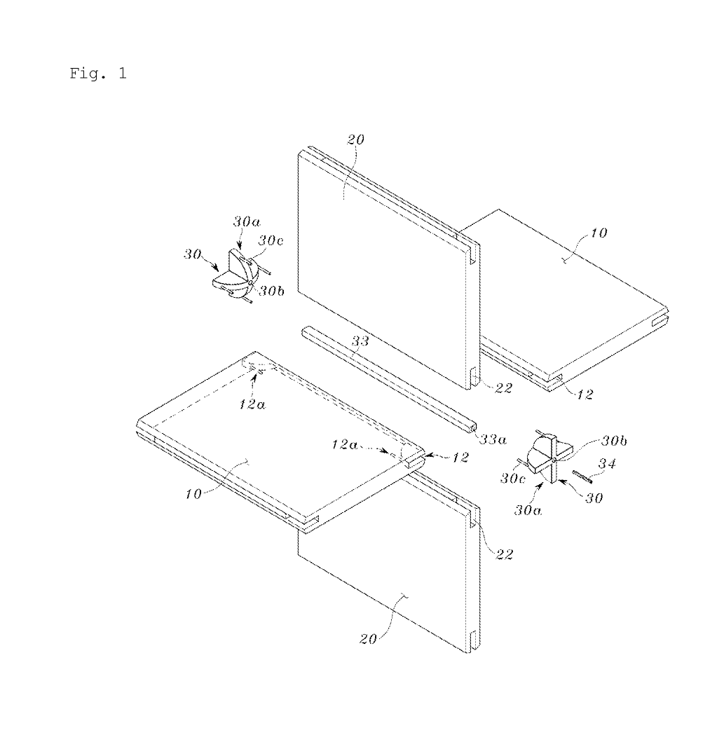

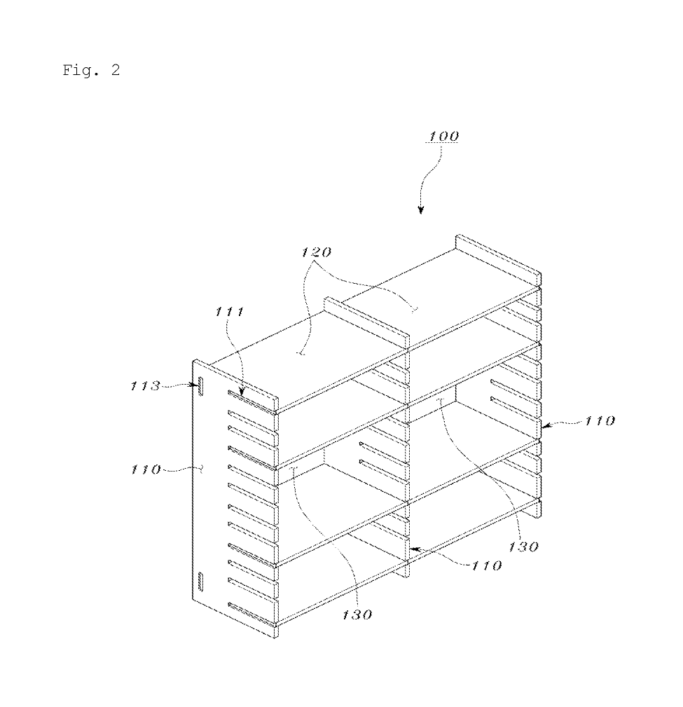

### MODE FOR INVENTION

The present invention provides a DIY leg frame that has at least two transverse holes where rectangular members are fitted for a user to easily and stably assemble DIY furniture in desired shape and size, and has a body with a predetermined length, in which one coupling hole is perpendicular to at least another coupling hole. Further, the present invention provides DIY furniture formed by vertically placing a plurality of DIY leg frames on the floor and fitting at least two rectangular members having predetermined lengths to the DIY leg frames such that they are perpendicular to each other through the DIY leg frames.

The scope of the present invention is not limited to the following embodiments and the present invention may be modified in various ways by those skilled in the art without departing from the spirit of the present invention/

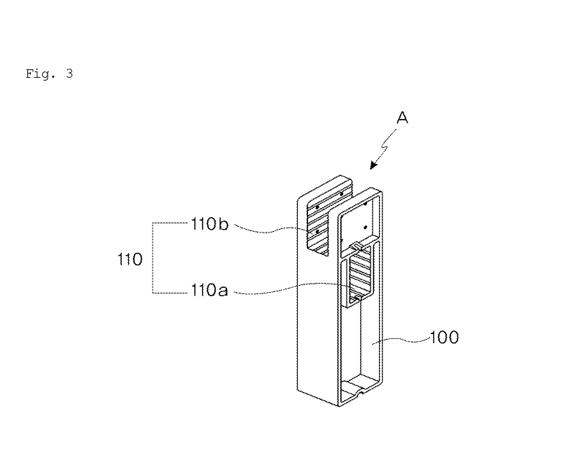

Hereinafter, embodiments of a DIY leg frame and DIY furniture using the DIY leg frames of the present invention are described in detail with reference to FIGS. 3 to 17.

A DIY leg frame of the present invention, as shown in FIG. 3, has a body 100 that has a predetermined length and has coupling holes 110 transversely formed and the body 100 may be made of various materials, depending on places where it is used or preferences of users.

Rectangular members B having predetermined lengths are fitted into the coupling holes 110 and the body 100 has at least two coupling holes 110, in which one coupling hole 110 is formed perpendicular to at least another coupling hole 110. The term ‘perpendicular’ means, though not shown in the figures, that coupling holes 110 are perpendicular to each other in the same plane, but, as shown in FIG. 3, that coupling holes 110 are formed in different planes so that rectangular members B are fitted in the coupling hole 110 without interfering with each other.

A piece of DIY furniture can be firmly manufactured by fitting at least two rectangular members B into each of a plurality of bodies 100. Further, since the coupling holes 110 are formed through the body 100, rectangular members B can be fitted through the body 100. Accordingly, different rectangular members B can be coupled to rectangular members B fitted in the holes, so a user can assemble various types of furniture with desired shapes and sizes. By this extensibility, a DIY leg frame of the present invention can be assembled in large quantity, so providers can produce the DIY leg frames at low costs and users can assemble DIY furniture at low costs.

As described above, the coupling holes 110 are arranged in the longitudinal direction of the body 100, so rectangular members B are fitted in the coupling holes 110 without interfering with each other. According to this structure, rectangular members B are fitted through the coupling holes 110, so a piece of furniture can be firmly assembled. Further, when a rectangular member B is fitted through any one of two coupling holes 110 formed in the same plane, a rectangular member B cannot be fitted into the other coupling hole 110, so a specific finishing member may be put into the coupling hole 110 for aesthetic appearance. However, when the coupling holes 110 are arranged in the longitudinal direction of the body 100, there is no specific material such as the finishing member, so the cost can be reduced.

The coupling holes 110, as shown in FIG. 3, include a through-hole 110a formed through the body 100 and an open hole 110b formed at an end of the body 100 to be open upward or downward. The through-hole 110a is generally used to make and support a frame for manufacturing DIY furniture and the open hole 110b is generally used for placing a top plate or a bottom plate composed of a plurality of rectangular members B on the upper end or the lower end of a rectangular member B fitted therein.

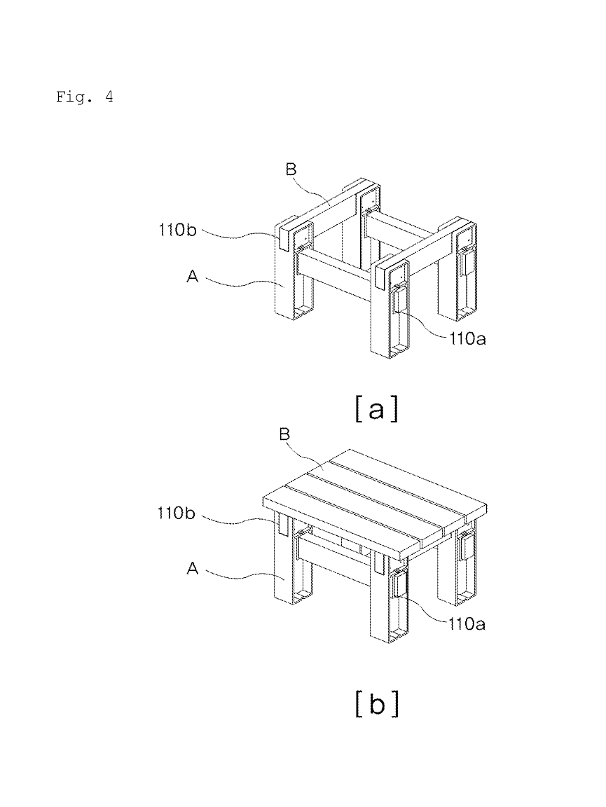

An example of DIY furniture using the DIY leg frame A described above is described. As shown in FIGS. 4a and 4b, a plurality of DIY leg frames A are vertically placed on the floor and then rectangular members B having predetermined lengths are fitted to the DIY leg frames A. In detail, the DIY leg frames A each have at least two coupling holes 110 formed transversely through them to fit rectangular members B, in which one coupling hole 110 is perpendicular to at least another coupling hole 110. Accordingly, as shown in FIG. 4a, at least two rectangular members B are fitted in the DIY leg frames A to be perpendicular to each other, thereby forming DIY furniture or a frame of DIY furniture.

When an open hole 110b that is open upward or downward is formed at an end of each of the DIY leg frames A, rectangular members B are fitted in the open holes 110b and a top plate or a bottom plate composed of a plurality of rectangular members B can be fastened to the rectangular members B fitted in the open holes 110b. As shown in FIG. 4b, it is possible to assemble DIY furniture such as a chair or a table by forming open holes 110b that are open upward, fitting rectangular members B into the open holes 110b, and then fastening a top plate composed of a plurality of rectangular members B such that the rectangular members B of the top plate are perpendicular to the rectangular members B fitted in the open holes 110b.

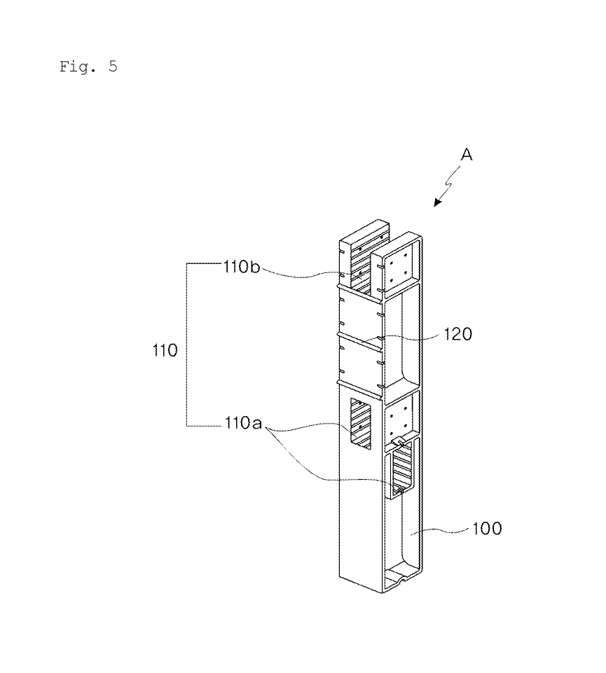

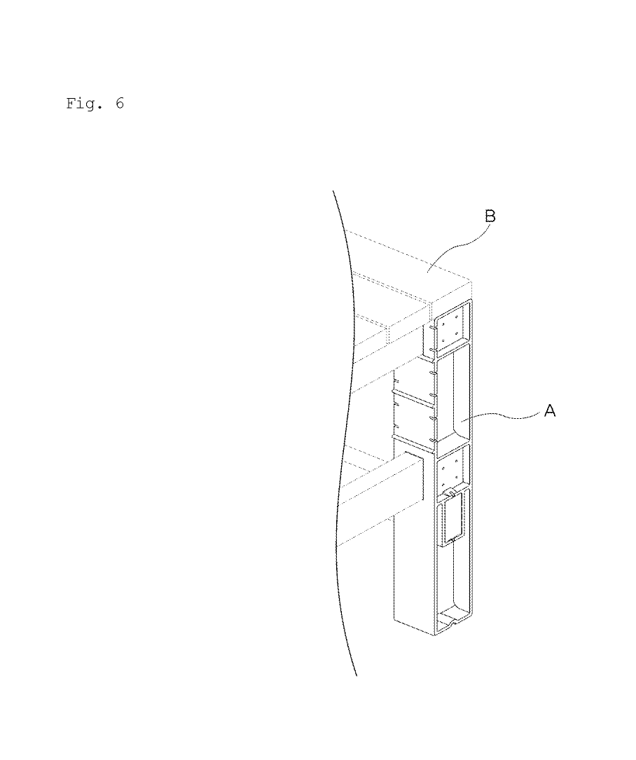

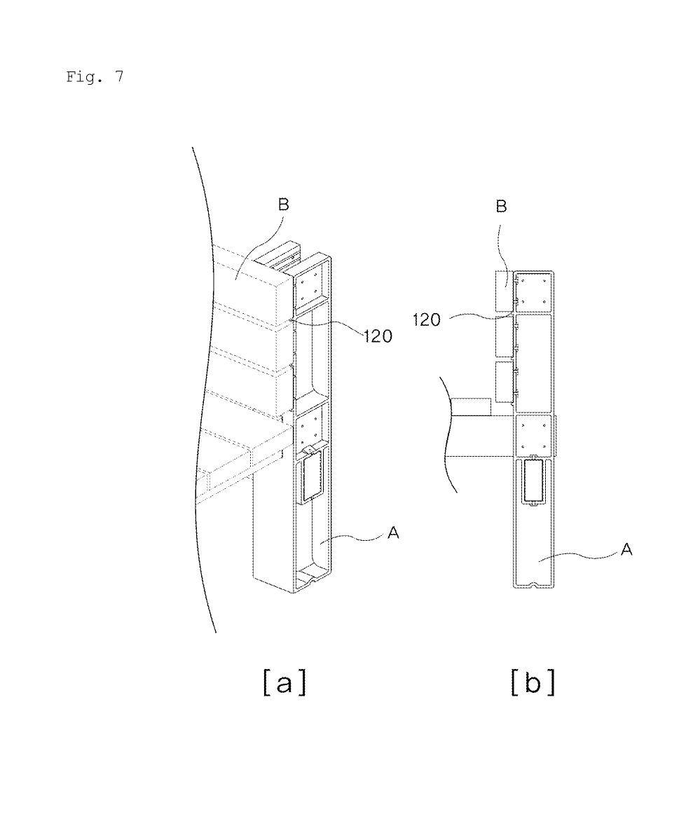

Further, as shown in FIG. 5, at least one of the coupling holes 110 may be spaced at a predetermined distance from another coupling hole 110. Accordingly, as shown in FIGS. 6 and 7a, it is possible to adjust the height of DIY furniture to be assembled or to make a back etc., thereby further increasing variability of use.

Further, steps 120 protruding transversely may be formed on the body 100, as shown in FIG. 5, and rectangular members B are placed on the steps 120. In particular, as shown in FIGS. 7a and 7b, when a plurality of steps 120 is formed on the outer sides of the body 100, between the coupling holes 110 spaced at a predetermined from each other, it is possible to make a back of a bench by transversely arranging rectangular members B on the steps 120.

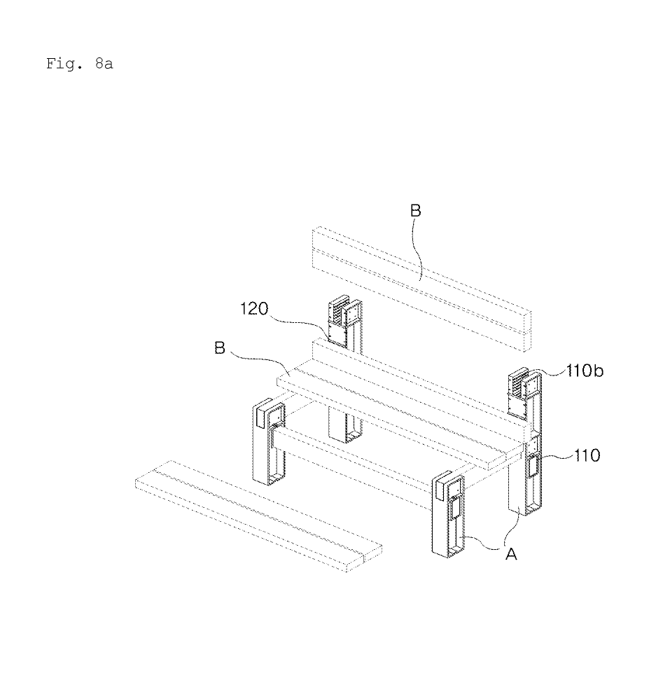

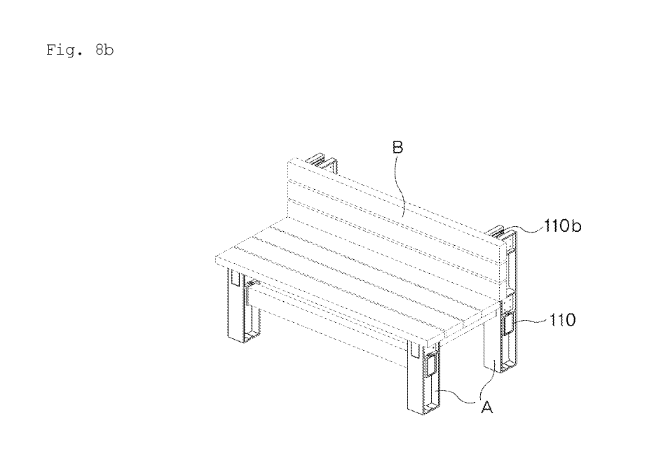

An example of manufacturing a bench that is a piece of DIY furniture using the DIY leg frame A described above will now be described. As shown in FIG. 8a, four DIY leg frames A are vertically placed on the floor and steps 120 that transversely protrude are formed on the outer sides of two of the DIY leg frames A under the assumption that at least two rectangular members B are fitted in the DIY leg frames A to be perpendicular to each other. One of the coupling holes 110 of the DIY leg frames A having the steps 120 may be spaced at a predetermined distance from at least one coupling hole 110 and the steps 120 may be formed on the outer sides between the coupling holes 110 spaced at a predetermined distance from each other. Further, it is assumed that an open hole 110b that is open upward is formed at the upper end of each of the four DIY leg frames A.

As shown in FIG. 8a, at least two rectangular members B are fitted perpendicular to each other into one DIY leg frame A, a top plate composed of a plurality of rectangular members B is fastened to the rectangular members B fitted in the open holes 110b of the shorter DIY leg frames A, and then a plurality of rectangular members B are put on the steps 120 to form and fix a back, whereby a bench shown in FIG. 8b can be assembled.

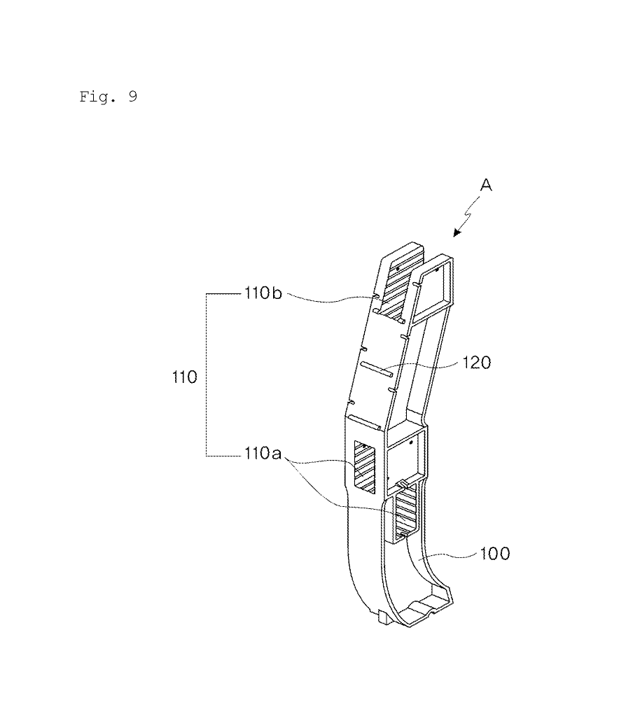

On the other hand, as shown in FIG. 9, the portion of the body 100 where the steps 120 are formed may bend at a predetermined angle, which is useful for forming a back inclined at an angle of DIY furniture so that a user can lean against the back in a comfortable position and aesthetic appearance is improved

Further, when the coupling holes 110 include the open hole 110b that is formed at an end of the body 100 and open upward or downward, as shown in FIG. 10, a finishing member 140 formed to correspond to the open hole 110b and to be fitted into the open hole 110b may be further included. The finishing member 140 can prevent dirt from accumulating in the open hole 110b by closing the open hole 110 when a rectangular member B is not fitted in the open hole 110b, and improves the external appearance.

An example of manufacturing a bench that is a piece of DIY furniture using the DIY leg frames A described above is described.

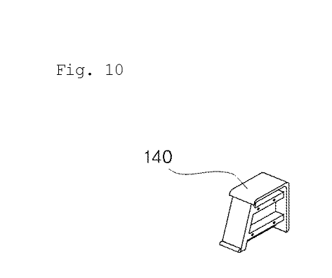

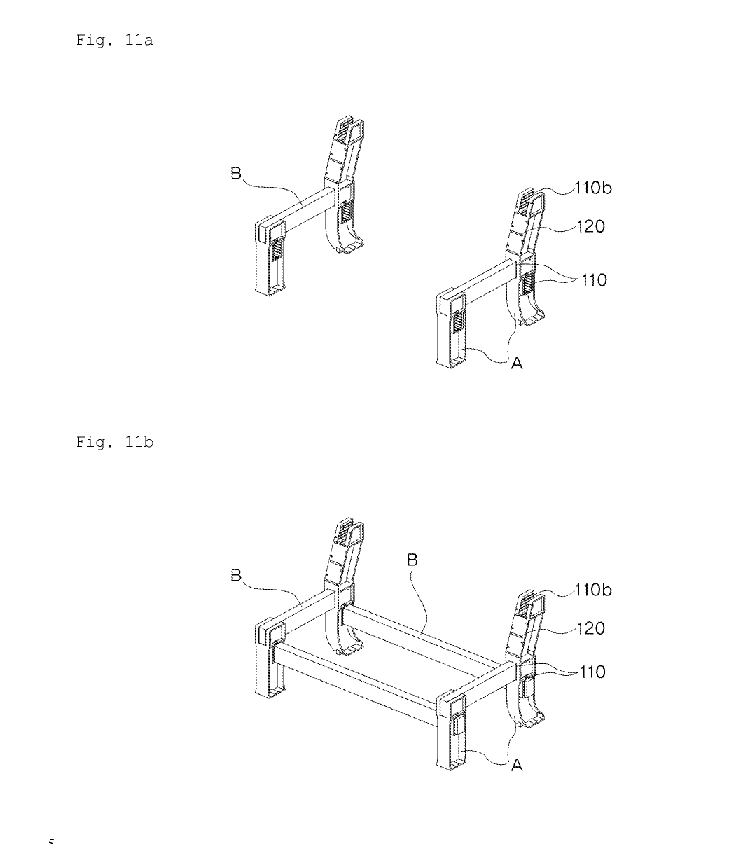

In this example, total four DIY leg frames A are used and, as shown in FIG. 11a, all of the DIY leg frames A have coupling holes 110 that are formed perpendicular to each other and arranged in the longitudinal direction of the bodies 100, in which one of the coupling holes 110 is formed to be open upward at an end of each of the bodies 100. Further, steps 120 are formed at two of the DIY leg frames A, the open hole 110b is spaced at a predetermined distance from at least one coupling hole 110, and the steps 120 are formed on the outer side between the coupling holes 110 spaced at a predetermined distance from each other. In particular, the portions, where the steps 120 are formed, of the bodies 100 are bent at a predetermined angle.

As shown in FIGS. 11a and 11b, these four DIY leg frames A are vertically placed on the floor, rectangular members B are fitted in the DIY leg frames A perpendicularly to each other, and then a top plate composed of a plurality of rectangular members B is fastened to the rectangular members B fitted in the open holes 110b, thereby completing the seat of a bench that a user sits on. Thereafter, the back of the bench is formed by putting/fixing rectangular members B on the steps 120, as shown in FIG. 11c, and then the open holes 110b are closed by putting the finishing members 140 into the open holes 110b.

Further, an example of manufacturing a picnic table-chair that is also an example of DIY furniture using the DIY leg frames A described above will now be described.

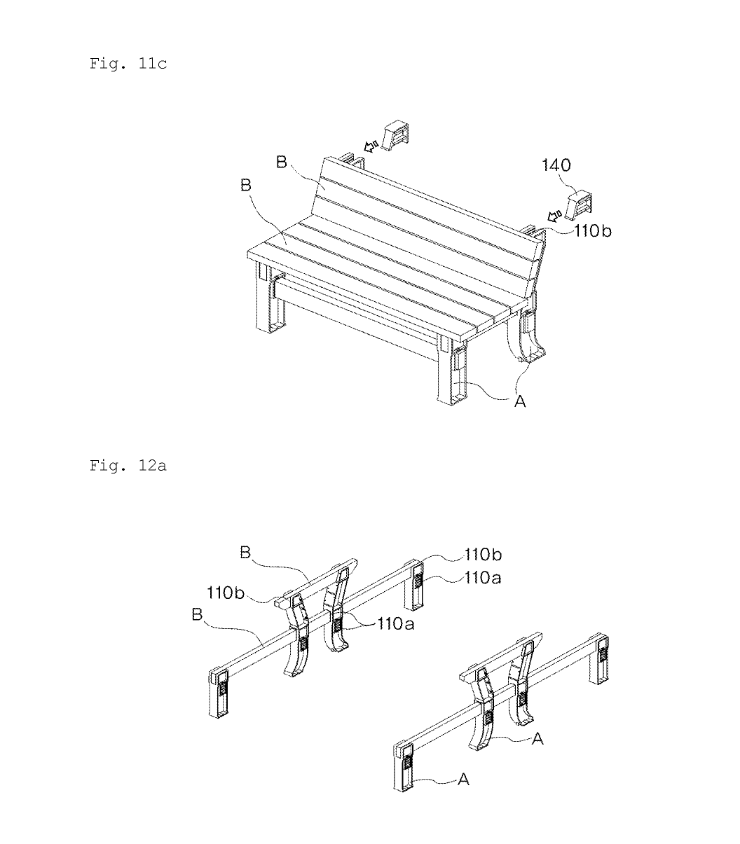

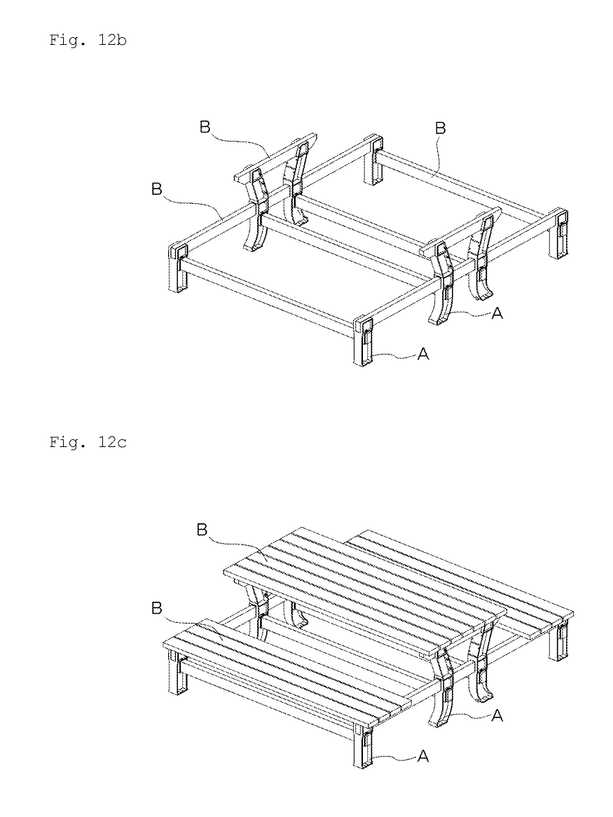

In this example, a total of eight DIY leg frames A are used and, as shown in FIG. 12a, all of the DIY leg frames A have coupling holes 110 that are formed perpendicular to each other and arranged in the longitudinal direction of the bodies 100, in which one of the coupling holes 110 is formed to be open upward at an end of each of the bodies 100. The open holes 110b formed at four of the DIY leg frames A are each spaced at a predetermined distance from at least one coupling hole 110. Longer DIY leg frames A may be bent at a predetermined angle, as shown in FIG. 12a, but it is not necessary in assembly of a picnic table-chair.

First, as shown in FIG. 12a, rectangular members B are fitted into the open holes 110b of two of the longer DIY leg frames A, and the through-holes 110a of the longer DIY leg frames A and the open holes 110b of the shorter DIY leg frames A are connected by rectangular members B. After two sets are formed, as described above, they are arranged, as shown in FIG. 12b, and then corresponding DIY leg frames are connected by fitting rectangular members B. Thereafter, as shown in FIG. 12c, three sets of top plates composed of a plurality of rectangular members B are formed and then fastened to the rectangular members B fitted in the open holes 110b of the longer/shorter DIY leg frames, whereby it is possible to assemble a picnic table-chair having chairs and a table formed in a single unit.

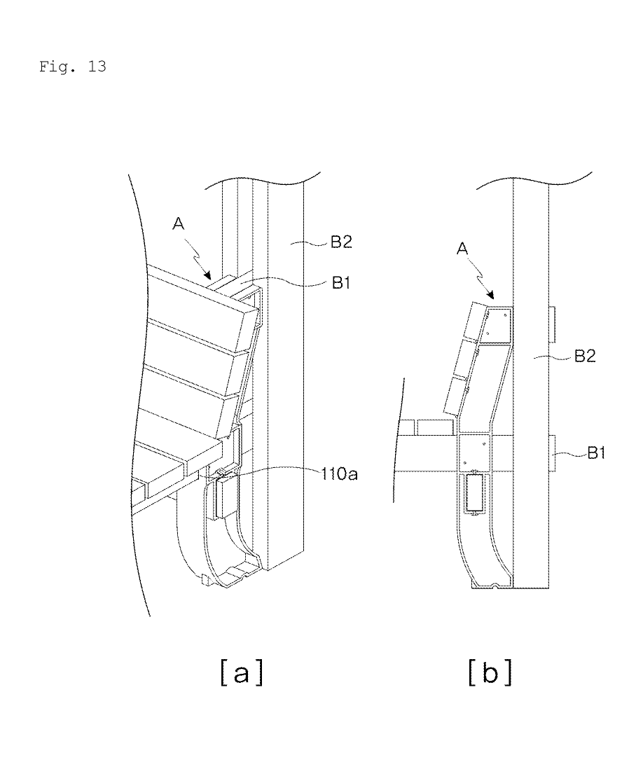

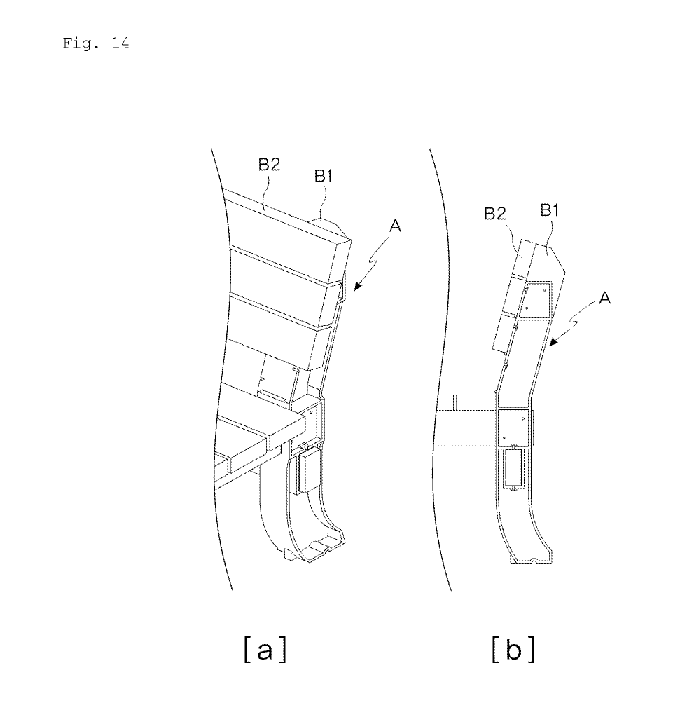

When the coupling holes 110 formed in the bodies 100 include open holes 110b formed at an end of each of the bodies 100 to be open upward or downward, as shown in FIGS. 13 and 14, at least one of rectangular members B that are fitted through the DIY leg frames A may protrude at one end or both ends through the DIY leg frames A.

Referring to FIGS. 13 and 14, an end of a rectangular member B1 fitted in the open hole 110b perpendicularly to the rectangular member B fitted in another coupling hole 110 protrudes and at least one rectangular member B2 is coupled to the protruding portion perpendicularly to the protruding rectangular member B1. Accordingly, when DIY furniture is assembled, a prop can be formed, as shown in FIG. 13, and the height of the portion that is the back in the example shown in FIG. 14 can be increased. Further, though not shown in the figures, the rectangular member B1 is fitted into the open hole 110b in the longitudinal direction of the DIY leg frame A and a plurality of rectangular members B2 is coupled perpendicular to the protruding rectangular member B1, whereby it is possible to assemble back panels of various DIY furniture including a bookshelf.

An example of manufacturing a park bench that is a piece of DIY furniture using the DIY leg frames A described above will now be described.

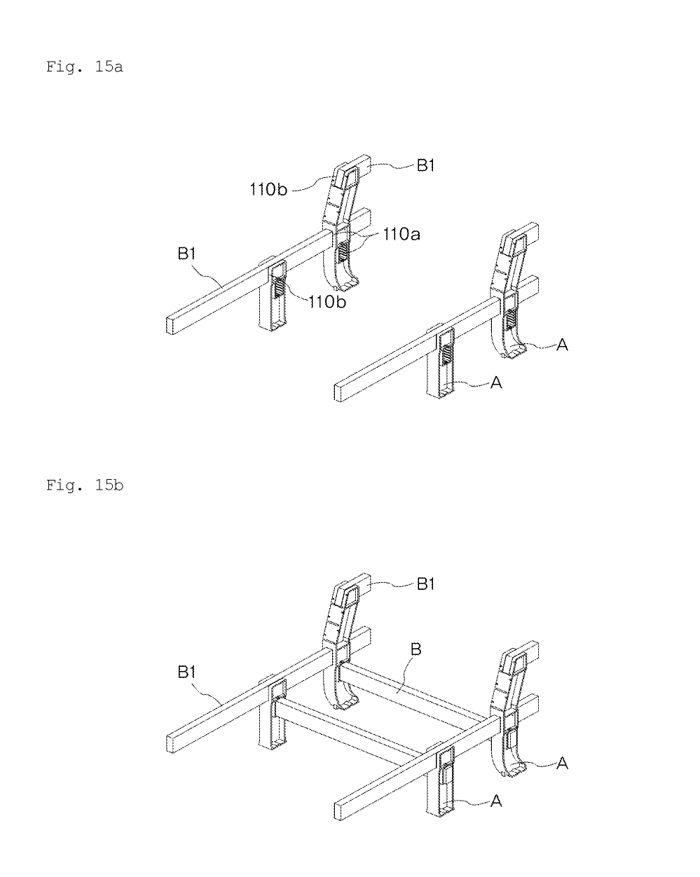

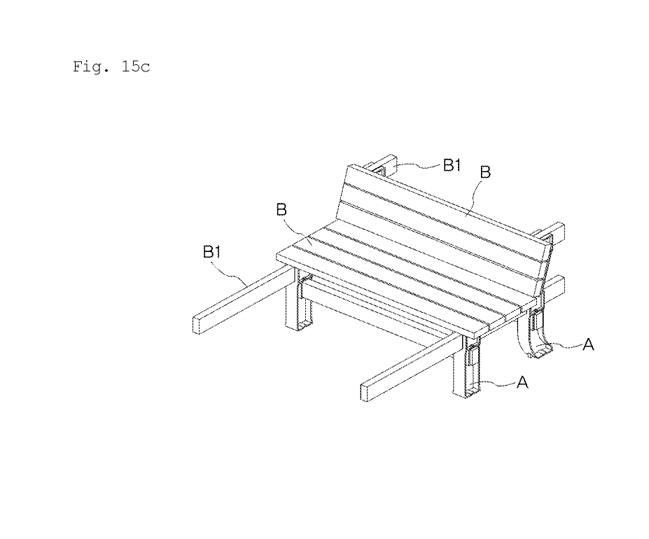

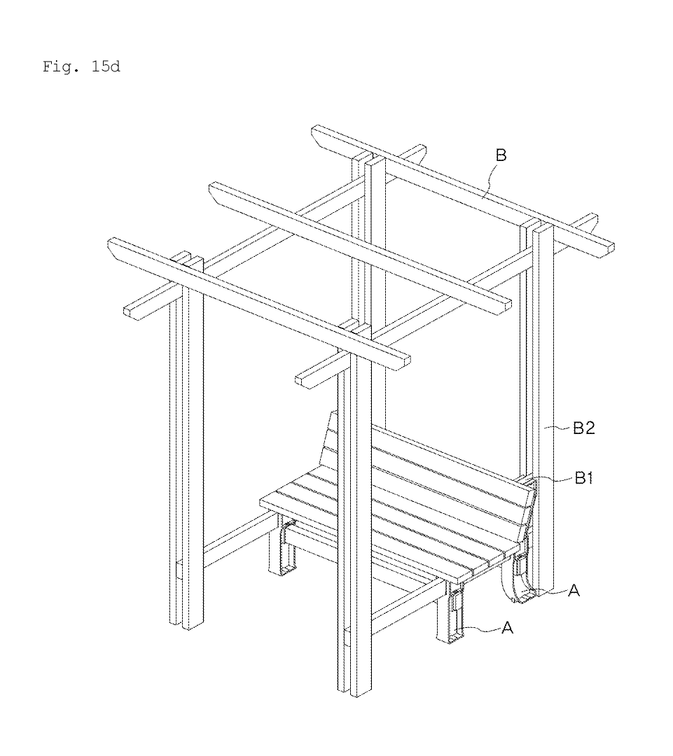

Rectangular members B are fitted into the through-holes 110a of longer DIY leg frames A and the open holes 110b of the shorter DIY leg frames A, that is, as shown in FIG. 15a, the rectangular members B are fitted with both ends protruding and the rectangular members B are fitted in the open holes 110b of the longer DIY leg frames A with an end protruding rearward. After two sets are formed, as described above, they are arranged, as shown in FIG. 15b, and then corresponding DIY leg frames are connected by fitting rectangular members B. Thereafter, a top plate composed of a plurality of rectangular members B is fastened, thereby forming a seat and a back, as shown in FIG. 15c.

Rectangular members B2 are coupled, perpendicularly to the protruding rectangular members B1, that is, upward, to the portions that protrude rearward from the through-holes 110a of the longer DIY leg frames A and the portions that protrude forward from the open holes 110b of the shorter DIY leg frames A, thereby forming props. Further, rectangular members B are perpendicularly coupled to the rectangular members that are the props, thereby forming a roof framework.

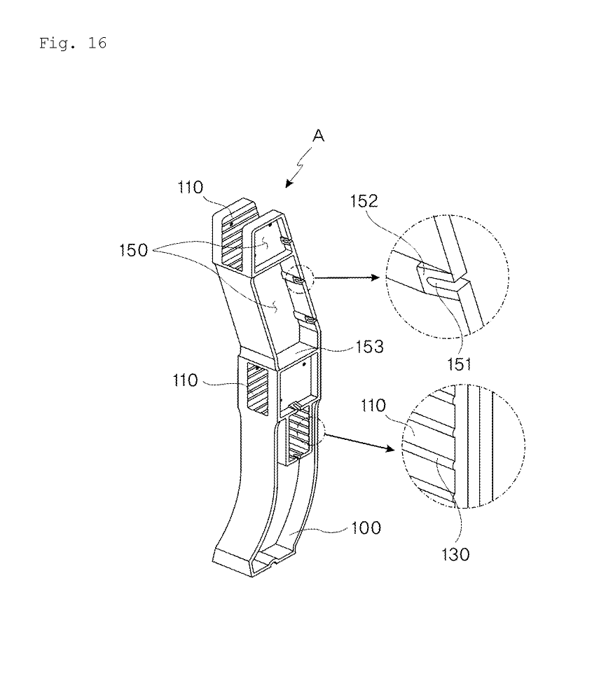

In order to easily couple a rectangular member to the body 100 when manufacturing DIY furniture using DIY leg frames of the present invention, as shown in FIG. 16, a plurality of fitting projections 130 may be formed on the inner side of the coupling hole 110. The fitting protrusions 130 may be formed in the direction in which a rectangular member B is fitted, and when the coupling hole 110 is formed in the lateral direction of the body 100, the fitting projections 130 may be formed in the lateral direction on the inner side of the coupling hole 110. Friction between the coupling hole 110 and a rectangular member B that is fitted into the coupling hole 110 is decreased by the fitting projections 130, so a user can easily fit a rectangular member B into the coupling hole 110.

Further, in order to more firmly couple a rectangular member B to the body 100 when manufacturing DIY furniture using DIY leg frames of the present invention, screws may be used. The screws fasten the rectangular member B fitted in the coupling hole 110, through the body 100. Fixing spaces 150 recessed at a predetermined depth may be formed on both sides of the body 100, as shown in FIG. 16 and the thickness of the body 100 that screws are supposed to be driven into is decreased by the fixing spaces 150, so the rectangular member B fitted in the coupling hole 110 can be easily fastened to the body 100 by screws. Further, the screws do not protrude outward after being driven, so it is possible to prevent a user from being hurt due to the screws when using the DIY furniture.

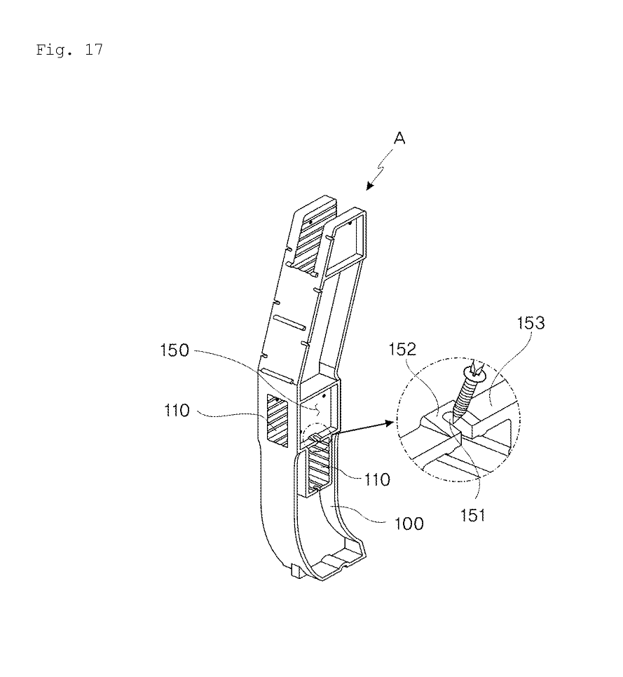

Further, as shown in FIGS. 16 and 17, screw holes 151 where screws for firmly fastening the body 100 and the rectangular member B fitted in the body 100 can be inserted may be formed on the inner sides of the fixing spaces 150. The screw holes 151 may have an inclined surface 152 that is inclined upward as it goes to the inside of the fixing space 150. Accordingly, a screw that is inserted into the screw hole 151 is inclined toward the center of the rectangular member B coupled to the body 100, so the fixing force is increased. Further, the inclined surface 152 faces the outside, so a driver or an electric drill can be used to drive a screw into the screw hole 151 formed on the inner side of the recessed fixing space 150.

For example, when a coupling hole 110 is spaced at a predetermined distance from another coupling hole 110 in the body 100, a rectangular member B may be coupled to the outer side of the body 100 with the spaced coupling holes 110, and as described above, a step 120 may be formed and a rectangular member B may be seated on the step 120. In order to firmly fix the rectangular member B seated on the step 120, as shown in FIG. 16, the screw hole 151 having the inclined surface 152 may be formed between the coupling holes 110 spaced at a predetermined distance from each other and the body 100 and a rectangular member B can be firmly fastened by a screw driven in the screw hole 151.

Further, as shown in FIGS. 16 and 17, the fixing space 150 may be recessed while forming an border 153 dividing coupling holes 110 and a screw hole 151 may be formed at the border 153. Accordingly, even if a plurality of coupling holes 110 is perpendicularly formed and arranged adjacent to each other in the longitudinal direction of the body 100, rectangular members B fitted in the coupling holes 110 can be fixed by screws.

Since a rectangular member B can be firmly fitted into a DIY leg frame A of the present invention, DIY furniture can be firmly assembled. The rectangular members B can be fitted through the DIY leg frame A and another coupling member B can be coupled to the rectangular member B that has been previously fitted, so it is possible to assemble various types of DIY furniture including the pieces of DIY furniture described above.

1. A DIY leg frame having at least two coupling holes (110) that are transversely formed to fit rectangular members (B) and having a body (100), wherein one of the coupling holes (110) is formed perpendicular to at least another coupling hole (110).

2. The DIY leg frame of claim 1, wherein the coupling holes (110) are arranged in a longitudinal direction of the body (100).

3. The DIY leg frame of claim 1, wherein steps (120) protruding transversely to support the rectangular members (B) are formed on an outer side of the body (100).

4. The DIY leg frame of claim 3, wherein a portion of the body (100) where the steps (120) are formed is bent at a predetermined angle.

5. The DIY leg frame of claim 1, wherein the coupling holes (110) include a through-hole (110a) formed in the body (100) and an open hole (110b) formed at an end of the body (100) and being open upward or downward.

6. The DIY leg frame of claim 5, further comprising a finishing member (140) fitted in the open hole (110b) including a portion formed to correspond to the open hole (110b).

7. The DIY leg frame of claim 1, wherein a plurality of projections (130) is formed on an inner side of each of the coupling holes (110).

8. The DIY leg frame of claim 1, wherein a fixing space (150) recessed at a predetermined depth is formed on both sides of the body (100) and a screw hole (151) that is inclined upward as the screw hole goes to the inside is formed on an inner sides of the fixing spaces (150).

9. The DIY leg frame of claim 8, wherein the fixing spaces (150) have a border (152) dividing the coupling holes (110) and the screw holes (151) are formed at the borders (152).

10. DIY furniture that is formed by vertically placing a plurality of DIY leg frames (A) on a floor and fitting rectangular members (B) having predetermined lengths to the DIY leg frames (A), wherein at least two rectangular members (B) are fitted through the DIY leg frames (A) perpendicularly to each other.

11. The DIY furniture of claim 10, wherein steps (120) protruding transversely are formed on outer sides of the DIY leg frames (A), portions where the steps (120) are formed are bent at a predetermined angle, and the rectangular members (B) are seated on the steps (120) to make a back.
